(19) United States
(12) Patent Application Publication
(10) Pub. No.: US 2026/0133528 A1
(43) Pub. Date: May 14, 2026

(54) IMAGE FORMING APPARATUS

(71) Applicant: KYOCERA Document Solutions Inc., Osaka (JP)

(72) Inventors: Einosuke KIKUCHI, Osaka (JP); Akira MATAYOSHI, Osaka (JP)

(73) Assignee: KYOCERA Document Solutions Inc., Osaka (JP)

(21) Appl. No.: 19/380,083

(22) Filed: Nov. 5, 2025

(30) Foreign Application Priority Data
Nov. 11, 2024 (JP) 2024-196578

(51) Int. Cl. G03G 15/00; G03G 15/043; G03G 15/06; G03G 15/16

(52) U.S. Cl. CPC G03G 15/5058; G03G 15/043; G03G 15/065; G03G 15/161; G03G 2215/00059

(57) ABSTRACT

An image forming apparatus includes an image carrying member, a charging device, an exposure device, a developing device, an intermediate transfer belt, a cleaning brush, an image density sensor, and a control portion. The control portion executes calibration including: a first adjustment process of changing an image forming condition based on a result of detection of a first reference image formed on the intermediate transfer belt; a first bare-surface-measurement process of detecting, after execution of the first adjustment process, a first-reference-image formation area; and a second adjustment process of changing, after execution of the first bare-surface-measurement process, the image forming condition based on a result of detection of a second reference image formed on the first-reference-image formation area. In a case where an output value of the image density sensor in the first bare-surface-measurement process is equal to or less than a threshold value, the second adjustment process is executed.

### INCORPORATION BY REFERENCE

This application is based on and claims the benefit of priority from Japanese Patent Application No. 2024-196578 filed on November 11, 2024, the contents of which are hereby incorporated by reference.

### BACKGROUND

The present disclosure relates to an image forming apparatus employing an intermediate transfer method in which a cleaning brush is used to remove residual toner from the surface of an intermediate transfer belt.

Conventionally, there has been known an intermediate transfer type image forming apparatus including an intermediate transfer belt that is endless-shaped and driven to rotate in a predetermined direction and a plurality of image forming portions arranged along the intermediate transfer belt. In such an image forming apparatus, toner images of respective colors are primarily transferred by the image forming portions onto the intermediate transfer belt so as to be sequentially superimposed on each other, and then the toner images are secondarily transferred onto a recording medium.

In the intermediate transfer type image forming apparatus, in a case where the intermediate transfer belt has an elastic layer, a cleaning device is used which includes, arranged in its housing, a cleaning brush that mechanically and electrically collects toner remaining on the surface of the intermediate transfer belt, a collection roller that collects toner from the cleaning brush, a scraper that scrapes off toner from the surface of the collection roller, and a conveyance spiral that conveys toner scraped off from the surface of the collection roller into a waste toner collection container.

On the other hand, in the intermediate transfer type image forming apparatus, a calibration operation is executed to adjust image density or color shift by detecting the density of a reference image (patch image) transferred onto the intermediate transfer belt. At that time, if a defect such as a scratch or contamination has occurred on the intermediate transfer belt, it may prevent the calibration operation from accurately adjusting image density or color shift.

### SUMMARY

According to one aspect of the present disclosure, an image forming apparatus includes an image carrying member, a charging device, an exposure device, a developing device, an intermediate transfer belt, a cleaning brush, an image density sensor, and a control portion. The image carrying member includes a photosensitive layer formed on a surface thereof. The charging device charges the surface of the image carrying member. The exposure device exposes, to light, the surface of the image carrying member having been charged by the charging device, thereby forming an electrostatic latent image with attenuated charge. The developing device includes a developer carrying member carrying a developer including toner, and develops the electrostatic latent image having been formed on the image carrying member into a toner image. The intermediate transfer belt, having an endless shape, rotates in contact with the image carrying member, thereby having the toner image primarily transferred thereto. The cleaning brush removes toner remaining on the intermediate transfer belt. The image density sensor detects density of the toner image having been primarily transferred onto the intermediate transfer belt. The control portion executes calibration to correct image density based on density of a reference image having been detected by an image density sensor. The calibration includes: a first adjustment process of detecting density of a first reference image formed on the intermediate transfer belt and adjusting an image forming condition based on a detection result; a first bare-surface-measurement process of detecting a first-reference-image formation area using an image density sensor when the intermediate transfer belt has rotated once or more after execution of the first adjustment process; and a second adjustment process of detecting, when the intermediate transfer belt has rotated once after execution of the first bare-surface-measurement process, density of a second reference image formed on the first-reference-image formation area, and changing, based on a detection result, an image forming condition that is different from the image forming condition adjusted in the first adjustment process. In a case where a fluctuation range of an output waveform of the image density sensor in the first bare-surface-measurement process is equal to or less than a threshold value, the control portion determines that a surface condition of the intermediate transfer belt is normal, and executes the second adjustment process.

### BRIEF DESCRIPTION OF THE DRAWINGS

FIG. 1 is a schematic view showing an inner configuration of an image forming apparatus according to one embodiment of the present disclosure.

FIG. 2 is a side sectional view showing a configuration around an intermediate transfer unit incorporated in the image forming apparatus.

FIG. 3 is an enlarged view around an image forming portion in FIG. 2.

FIG. 4 is a block diagram showing one example of a control path in the image forming apparatus.

FIG. 5 is a schematic diagram showing an example of calibration executed in the image forming apparatus.

FIG. 6 is a schematic diagram showing another example of calibration executed in the image forming apparatus.

FIG. 7 is a flowchart showing an example of controlling calibration executed in the image forming apparatus.

FIG. 8 is a graph showing results of bare surface measurement obtained when the performance of a cleaning brush is normal.

FIG. 9 is a graph showing results of bare surface measurement obtained when the performance of the cleaning brush has deteriorated.

FIG. 10 is a graph showing results of bare surface measurement obtained when an intermediate transfer belt has been rotated once more from the state shown in FIG. 9.

### DETAILED DESCRIPTION

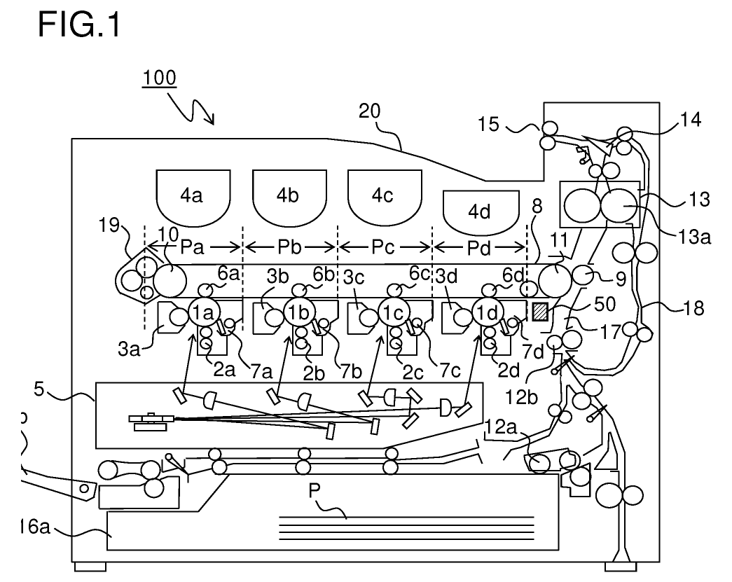

Hereinafter, an embodiment of the present disclosure will be described with reference to the accompanying drawings. FIG. 1 is a schematic view showing a configuration of an image forming apparatus 100 according to one embodiment of the present disclosure. Herein, a so-called tandem-type color printer is exemplified as the image forming apparatus 100.

In the main body of the image forming apparatus 100, four image forming portions Pa, Pb, Pc, and Pd are arranged in order from an upstream side (right side in FIG. 1) in a conveyance direction. These image forming portions Pa to Pd respectively include, arranged therein, photosensitive drums 1a, 1b, 1c, and 1d that each carry an image of a corresponding one of four different colors (cyan, magenta, yellow, and black), and sequentially form cyan, magenta, yellow, and black images through processes of charging, exposure, development, and transfer. Further, an intermediate transfer belt 8, which rotates in the counterclockwise direction in FIG. 1, is arranged adjacent to the photosensitive drums 1a to 1d.

Next, the image forming portions Pa to Pd will be described. Around the photosensitive drums 1a to 1d, along a drum rotation direction (the clockwise direction in FIG. 1), charging devices 2a to 2d, developing devices 3a to 3d, and cleaning devices 7a to 7d are arranged, respectively, and further, primary transfer rollers 6a to 6d are arranged facing the photosensitive drums 1a to 1d, respectively, with the intermediate transfer belt 8 therebetween. Further, on an upstream side of the photosensitive drum 1a in a rotation direction of the intermediate transfer belt 8, a belt cleaning unit 19 is disposed opposite a tension roller 10 with the intermediate transfer belt 8 therebetween.

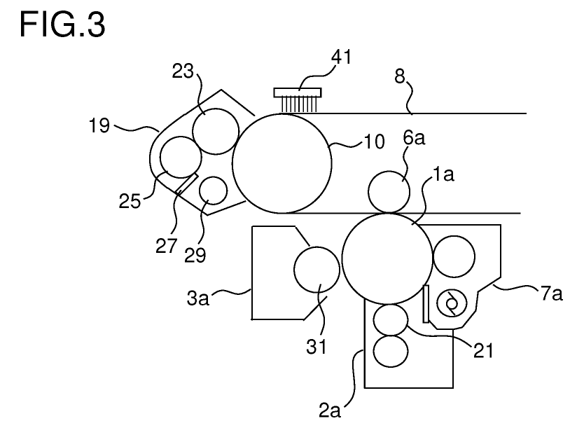

Next, a description will be given of an image forming procedure in the image forming apparatus 100. When image data is fed from a host device such as a personal computer, first, the charging devices 2a to 2d uniformly charge surfaces of the photosensitive drums 1a to 1d, respectively. Subsequently, the exposure device 5 executes light irradiation based on the image data, thereby forming electrostatic latent images on the photosensitive drums 1a to 1d based on the image data. The developing devices 3a to 3d are each loaded with a predetermined amount of a corresponding one of two-component developers (hereinafter simply referred to as developers) replenished from toner containers 4a to 4d, respectively, the developers each including toner of a corresponding one of the four colors, namely, cyan, magenta, yellow, and black. The developing devices 3a to 3d each include a developing roller 31 (see FIG. 3) that carries the developer thereon.

By the developing roller 31, toner included in the developer is supplied onto, and electrostatically adheres to, each of the photosensitive drums 1a to 1d. Thereby, toner images are formed corresponding to the electrostatic latent images having been formed through the exposure by the exposure device 5.

Then, by the primary transfer rollers 6a to 6d, an electric field is applied at a predetermined transfer voltage between the primary transfer rollers 6a to 6d and the photosensitive drums 1a to 1d, respectively, and thereby, the cyan, magenta, yellow, and black toner images respectively on the photosensitive drums 1a to 1d are primarily transferred onto the intermediate transfer belt 8. Toner and other substances remaining on the surfaces of the photosensitive drums 1a to 1d after the primary transfer are removed by the cleaning devices 7a to 7d, respectively.

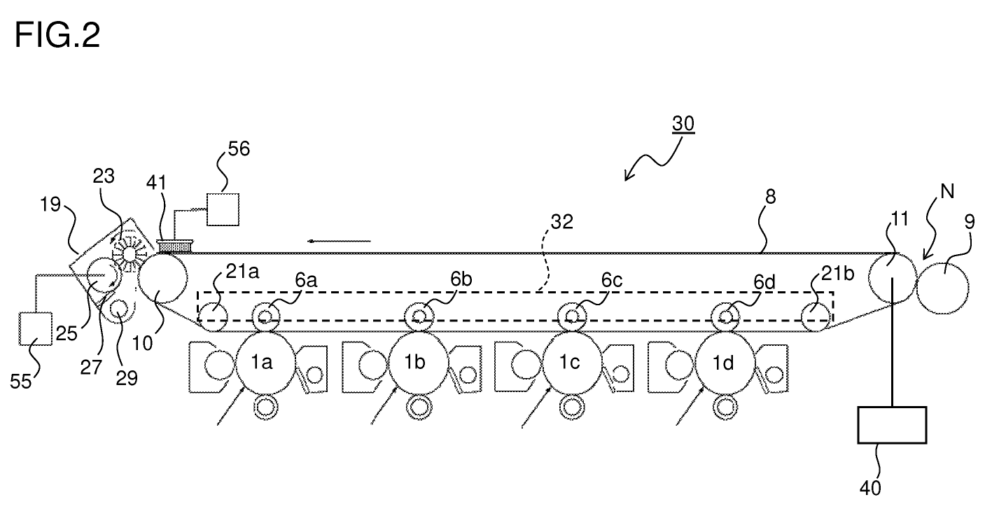

A transfer sheets P, onto which the toner images are to be transferred, is stored inside a sheet cassette 16a disposed at a lower part inside the image forming apparatus 100, or put on a manual feed tray 16b disposed on a side face of the image forming apparatus 100. The transfer sheet P, in the sheet cassette 16a or on the manual feed tray 16b, are sent out by a sheet feed roller 12a into a sheet conveyance path 17. The transfer sheet P is conveyed by a registration roller pair 12b, with predetermined timing, to a nip portion (secondary transfer nip portion N, see FIG. 2) between a secondary transfer roller 9, which is arranged adjacent to the intermediate transfer belt 8, and the intermediate transfer belt 8. After the toner images are secondarily transferred onto the transfer sheet P, the transfer sheet P is conveyed to a fixing portion 13. Toner and other substances remaining on the surface of the intermediate transfer belt 8 are removed by the belt cleaning unit 19.

After being conveyed to the fixing portion 13, the transfer sheet P is heated and pressed by a fixing roller pair 13a, and thereby the toner images are fixed onto the surface thereof to form a predetermined full-color image. After the full-color image is formed thereon, the transfer sheet P is discharged from the sheet conveyance path 17 onto a discharge tray 20 via a discharge roller pair 15 as it is (or after being delivered into a reverse conveyance path 18 by a branching portion 14 to have images formed on both sides thereof).

At a position opposite the drive roller 11 across the intermediate transfer belt 8, an image density sensor 50 is disposed. Typically used as the image density sensor 50 is an optical sensor that includes a light emitting element constituted of an LED or the like and a light receiving element constituted of a photodiode or the like. To measure a toner adhesion amount on the intermediate transfer belt 8, patch images (reference images) formed on the intermediate transfer belt 8 are irradiated with measurement light from the light emitting element, so that the measurement light enters the light-receiving element as light reflected by the toner and light reflected by the belt surface.

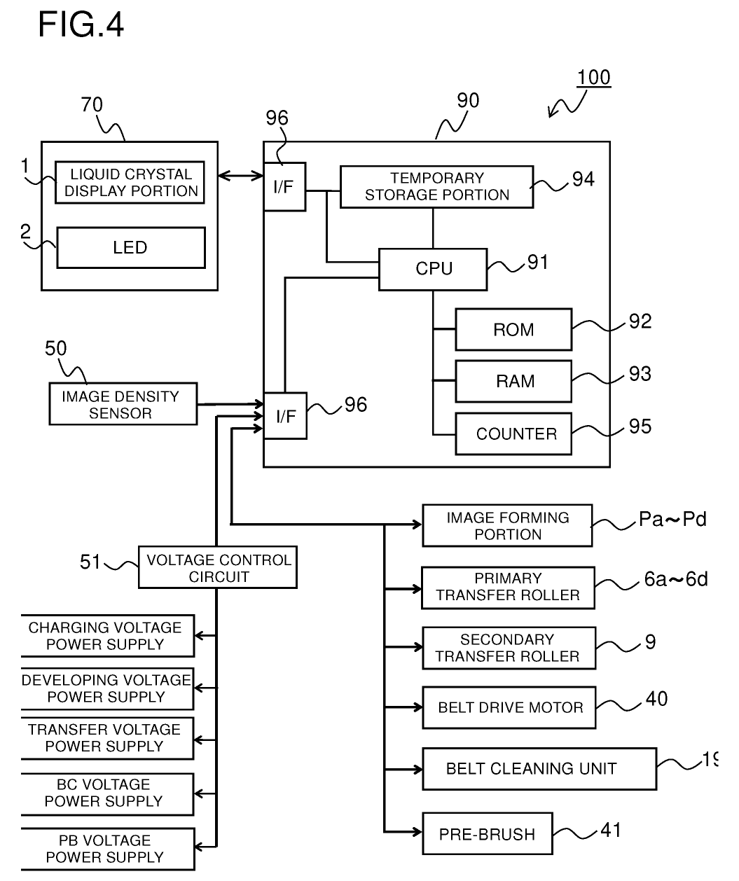

The light reflected from the toner and the belt surface includes specular reflection light and diffused reflection light. The specular reflection light and the diffused reflection light are separated through a polarization splitting prism and then enter separate light receiving elements. Each of the light receiving elements performs photoelectric conversion on the received specular or diffused reflection light and outputs an output signal to a control portion 90 (see FIG. 4).

Then, image densities (toner amounts) and positions of the patch images are detected based on change in characteristics of the output signals of the specular reflection light and the diffused reflection light, and they are compared with a predetermined reference density and a predetermined reference position, so as to adjust a characteristic value of development voltage, exposure starting position and timing of the exposure device 5, etc. In this manner, image density correction and color shift correction (calibration) are performed for each color.

FIG. 2 is a side sectional view showing a configuration around an intermediate transfer unit 30 incorporated in the image forming apparatus 100. FIG. 3 is an enlarged view around the image forming portion Pa in FIG. 2. The intermediate transfer unit 30 includes the intermediate transfer belt 8 stretched between a tension roller 10 disposed on the upstream side and the drive roller 11 disposed on the downstream side, the primary transfer rollers 6a to 6d that are in contact with the photosensitive drums 1a to 1d via the intermediate transfer belt 8, backup rollers 21a and 21b, the belt cleaning unit 19, a pre-brush 41, and a roller contact/separation mechanism 32. To the drive roller 11, a belt drive motor 40 is connected via a gear train (unillustrated).

The intermediate transfer belt 8 is an elastic rubber belt including an elastic layer laid on the surface of a base layer thereof. By providing the elastic layer, it is possible to prevent a dropout phenomenon caused in an image by stress concentration during the secondary transfer. Used as a material of the base layer is, for example, a polyimide resin, a PVDF (polyvinylidene difluoride) resin, or the like mixed with a conductive material such as an ion conductive material, a conductive carbon, etc., for conductivity. Used as a material of the elastic layer is, for example, a hydrin rubber, a chloroprene rubber, a polyurethane rubber, etc. A coat layer may further be provided to protect the elastic layer. Used as a material of the coat layer is an acrylic resin, a silicone resin, a fluororesin, etc.

The belt cleaning unit 19 includes, arranged in a housing thereof, the cleaning brush 23, a collection roller 25, a scraper 27, and a conveyance spiral 29. The cleaning brush 23 is disposed opposite the tension roller 10 with the intermediate transfer belt 8 therebetween. The cleaning brush 23 rotates in a direction (counterclockwise direction in FIG. 2) opposite to the movement direction of the intermediate transfer belt 8, thereby removing foreign matters, such as toner particles, carrier particles, paper powder, etc., remaining on the intermediate transfer belt 8.

The cleaning brush 23 includes a brush portion that contacts the collection roller 25, and the brush portion is formed of conductive fiber having an electrical resistance on the order of 1 to 900 MΩ.

The collection roller 25 rotates in contact with a surface of the cleaning brush 23 in a direction (clockwise direction in FIG. 2) opposite to the direction in which the cleaning brush 23 rotates, thereby collecting toner and other substances adhered on the cleaning brush 23. To the collection roller 25, a belt-cleaning voltage power supply 55 is connected to apply the collection roller 25 a cleaning voltage during the cleaning of the intermediate transfer belt 8. The cleaning voltage is a direct-current voltage having a polarity opposite to the normal charge polarity of the toner (hereinafter referred to as having a polarity opposite to that of the toner).

Specifically, since the toner used in the present embodiment is positively chargeable, the cleaning voltage applied is negative in polarity. Further, the tension roller 10 is grounded (earthed). As a result, toner and other substances having been removed from the intermediate transfer belt 8 are electrically and mechanically collected by the brush portion of the cleaning brush 23 and further caused to electrically move to the collection roller 25. The conveyance spiral 29 conveys the toner and other substances, having been scraped off from the collection roller 25 by the scraper 27, into an externally provided waste toner collection container (not shown).

The pre-brush 41 is disposed upstream of the belt cleaning unit 19 with respect to the movement direction of the intermediate transfer belt 8. To the pre-brush 41, a pre-brush voltage power supply 56 is connected, which applies, to the pre-brush 41, a pre-brush voltage (pre-cleaning voltage), which is a direct-current voltage having the same polarity as the toner charge polarity (hereinafter referred to as having the same polarity as the toner), thereby uniformizing the residual toner charge amount on the intermediate transfer belt 8. Since the toner used in the present embodiment is positively chargeable, the pre-brush voltage applied is positive in polarity. This helps the cleaning brush 23 to easily remove the residual toner on the intermediate transfer belt 8.

The pre-brush 41 is preferably formed of a material having a lower position in the triboelectric series as compared to the elastic layer of the intermediate transfer belt 8. The triboelectric series is a ranking of substances based on their tendency to become electrically charged when rubbed against each other. Substances that tend to acquire a positive (+) charge are placed higher in the series, while those that tend to acquire a negative (−) charge are placed lower.

The charge polarity of a substance changes depending on the material it is rubbed against. When two materials from different positions in the triboelectric series are rubbed together, the material higher in the series becomes positively charged, while the one lower in the series becomes negatively charged. In the present embodiment, through friction with the intermediate transfer belt 8, the pre-brush 41 acquires an electric charge with a polarity (here, negative polarity) opposite to that of the toner (here, positive polarity). Examples of the material for the pre-brush 41 described above include polyester and acrylics, for example.

The roller contact/separation mechanism 32 is capable of switching between a plurality of operational modes including: a color mode, in which the four primary transfer rollers 6a to 6d are respectively pressed against the photosensitive drums 1a to 1d via the intermediate transfer belt 8; a monochrome mode, in which only the primary transfer roller 6d is pressed against the photosensitive drum 1d via the intermediate transfer belt 8, and a primary transfer release state, in which the four primary transfer rollers 6a to 6d are all separated from the intermediate transfer belt 8.

FIG. 4 is a block diagram showing one example of a control path used in the image forming apparatus 100. Note that the image forming apparatus 100 is used with various controls executed on its various portions, which results in a complex control path of the entire image forming apparatus 100. Hence, the description here will focus on necessary part of the control path for implementation of the present disclosure.

The control portion 90 at least includes a CPU (central processing unit) 91 as a central processor, a ROM (read only memory) 92 which is a read-only storage portion, a RAM (random access memory) 93 which is a readable/writable storage portion, a temporary storage portion 94 that temporarily stores image data and the like, a counter 95, and a plurality of (here, two) I/Fs (interfaces) 96, which each transmit a control signal to various devices in the image forming apparatus 100 and receive an input signal from the operation portion 70. Further, the control portion 90 can be disposed anywhere inside the main body of the image forming apparatus 100.

The ROM 92 stores a control program for the image forming apparatus 100, data that stays unchanged during use of the image forming apparatus 100, such as numerical values necessary for controlling the image forming apparatus 100, etc. The RAM 93 stores necessary data generated during control of the image forming apparatus 100, data temporarily required for controlling the image forming apparatus 100, etc. Examples of the data stored in the RAM 93 include relationships between output values of the image density sensor 50 and image forming conditions during first and second adjustment process, which are performed during execution of calibration as described later, a threshold value for a fluctuation range of output values of the image density sensor 50 in a bare surface measurement process, etc. The counter 95 counts the number of printed sheets in a cumulative manner.

Further, the control portion 90 transmits control signals, from the CPU 91 through the I/Fs 96, to various portions and devices in the image forming apparatus 100. Further, from various portions and devices, signals indicating their conditions or input signals are transmitted to the CPU 91 through the I/Fs 96. Various portions and devices controlled by the control portion 90 include the image forming portions Pa to Pd, the exposure device 5, the primary transfer rollers 6a to 6d, the secondary transfer roller 9, the image density sensor 50, a voltage control circuit 51, the operation portion 70, etc.

The voltage control circuit 51 is connected to a charging voltage power supply 52, a development voltage power supply 53, a transfer voltage power supply 54, the belt-cleaning voltage power supply 55, and the pre-brush voltage power supply 56, and causes these power supplies to operate in response to output signals from the control portion 90. Specifically, in response to a control signal from the voltage control circuit 51, the charging voltage power supply 52 applies a predetermined charging voltage to charging rollers 21 provided inside the charging devices 2a to 2d. The development voltage power supply 53 applies a predetermined development voltage to developing rollers 31 provided inside the developing devices 3a to 3d. The transfer voltage power supply 54 applies a predetermined primary transfer voltage to the primary transfer rollers 6a to 6d and a predetermined secondary transfer voltage to the drive roller 11. The belt-cleaning voltage power supply 55 applies a predetermined cleaning voltage to the collection roller 25 of the belt cleaning unit 19. The pre-brush voltage power supply 56 applies a predetermined pre-brush voltage to the pre-brush 41. Note that, here, a secondary transfer voltage having the same polarity as the toner is applied to the drive roller 11 opposite the secondary transfer roller 9, but instead, a secondary transfer voltage having a polarity opposite to that of the toner may be applied to the secondary transfer roller 9.

The operation portion 70 includes a liquid crystal display portion 71 and LEDs 72 that indicate various states. A user operates a stop/clear button of the operation portion 70 to stop image formation, and operates a reset button to reset various settings of the image forming apparatus 100 to their default states. The liquid crystal display portion 71 is configured to indicate the condition of the image forming apparatus 100, the progress of image formation, and the number of printed copies. Various settings of the image forming apparatus 100 are made via a printer driver on a personal computer.

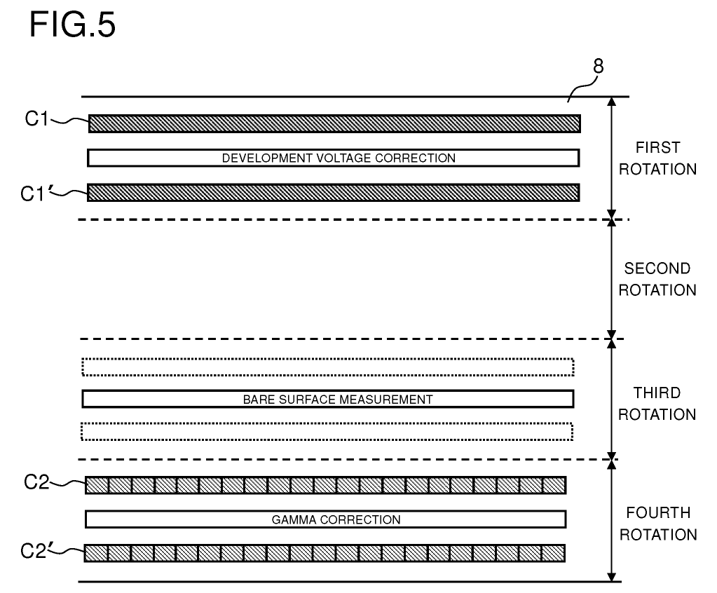

FIG. 5 is a schematic diagram showing an example of calibration executed in the image forming apparatus 100. As shown in FIG. 5, during a first rotation of the intermediate transfer belt 8, a reference image C1 (first reference image) for development voltage correction is formed. The reference image C1 includes a cyan solid image. The image density sensor 50 detects the image density of the reference image C1, and based on the detection result, the development voltage applied to the developing roller 31 of the developing device 3a for cyan is corrected. Subsequently, a reference image C1′ (first reference image) after the correction of the development voltage is formed, the image density sensor 50 detects the image density of the reference image C1′, and it is determined whether the image density (amount of toner developed) has reached a target value (a first adjustment process).

During a second rotation of the intermediate transfer belt 8, no reference image is formed, and only cleaning of the reference images C1 and C1′ is executed by the belt cleaning unit 19.

During a third rotation of the intermediate transfer belt 8, the image density sensor 50 detects the surface condition of the area on the intermediate transfer belt 8 where the reference images C1 and C1′ were formed (bare surface measurement), and it is determined whether the reference images C1 and C1′ have been collected by the belt cleaning unit 19 (a first bare-surface-measurement process).

During a fourth rotation of the intermediate transfer belt 8, a reference image C2 (second reference image) for correction (gamma correction) of gradation input value (exposure amount setting value) is formed. The reference image C2 includes patch images with a plurality of density levels, from the lightest to the darkest. Adjacent ones of the patch images are formed monochromatic such that their densities change at the boundary between them.

The image density sensor 50 detects image densities of the reference image C2, and based on the detection result, the gradation input value (exposure amount setting value) is corrected.

Specifically, toner adhesion amounts (toner densities) of the patch images are detected by the image density sensor 50 and are compared with predetermined target densities, and then an average value of density differences between the toner densities and the target densities is calculated. In accordance with the obtained average value of the density differences, a parameter value used for gradation correction is determined, and gradation correction is executed with respect to each density. Subsequently, a reference image C2′ (second reference image) after the correction of the gradation input value is formed, the image density sensor 50 detects the image densities of the reference image C2′, and it is determined whether the image density of each patch image has reached a target value (a second adjustment process).

In the development voltage correction, for the purpose of determining the maximum value of the developed toner amount, as the reference images C1 and C1′, solid images with large amounts of toner are formed on the intermediate transfer belt 8. As a result, with a brush cleaning method using the cleaning brush 23, it is not easy to collect the reference images C1 and C1′ all at once after the measurement of image densities.

To address this inconvenience, in the example shown in FIG. 5, after the execution of development voltage correction, the intermediate transfer belt 8 is rotated twice to collect the reference images C1 and C1′ separately during the two rotations. This makes it possible, even under the condition where the collection performance of the cleaning brush 23 has deteriorated, to prevent the reference images C1 and C1′ from affecting bare surface measurement performed prior to the execution of gamma correction.

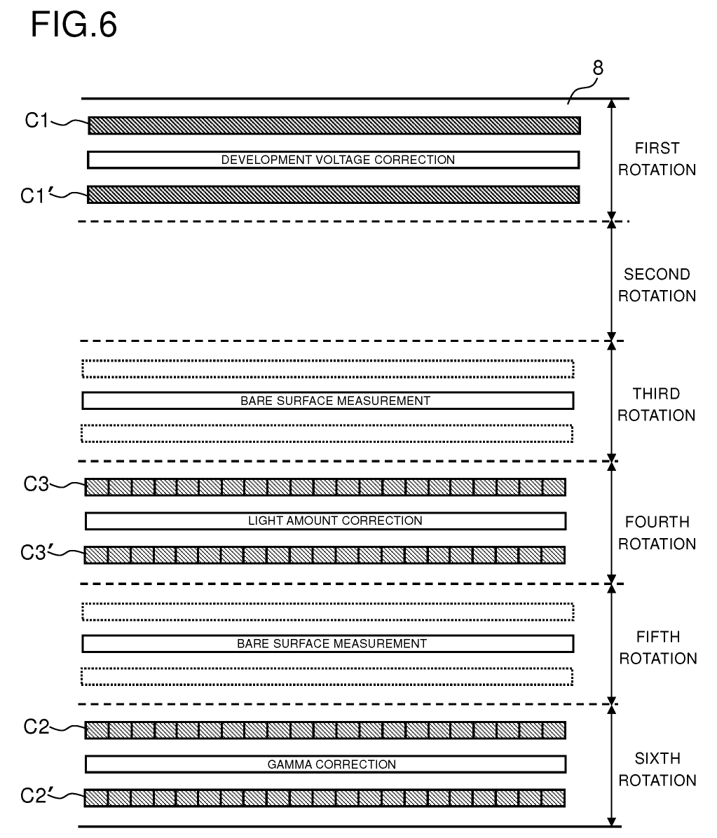

In the example shown in FIG. 5, the gradation input value is corrected after the development voltage is corrected, but the following method may be adopted, in which, as shown in FIG. 6, after the development voltage is corrected, reference images C3 and C3′ (second reference images) are formed to execute light amount correction to determine the light amount of laser light (laser power) of the exposure device 5, and after the execution of light amount correction, the reference images C2 and C2′ are formed to execute gradation input value correction. In the example shown in FIG. 6, after the execution of development voltage correction, the intermediate transfer belt 8 is rotated twice, and bare surface measurement (the first bare-surface-measurement process) is performed before light amount correction and gamma correction are executed.

The above description, which has dealt with calibration for cyan, is equally applicable to magenta, yellow, and black. Specifically, reference images M1, M1′, Y1, Y1′, K1, and K1′are formed to perform development voltage correction. Further, reference images M2, M2′, Y2, Y2′ K2, and K2′ are formed to perform gamma correction. Furthermore, reference images M3, M3′, Y3, Y3′, K3, and K3′ are formed to perform light amount correction.

Note that, in a case where the cleaning performance of the cleaning brush 23 has deteriorated more than expected, even if the intermediate transfer belt 8 is rotated twice to collect the reference images C1 and C1′ to K1 and K1′ separately during the two rotations, a small amount of toner may remain on the intermediate transfer belt 8, which may affect bare surface measurement. In a case where no threshold value is provided in bare surface measurement, the bare surface detected includes noise attributable to the residual toner, which may prevent appropriate execution of gamma correction or light amount correction after the bare surface measurement.

In a case where a threshold value is provided in bare surface measurement, the surface condition of the intermediate transfer belt 8 can be measured accurately, but in a case where the surface condition of the intermediate transfer belt 8 is not normal, calibration cannot be executed.

For example, in a case where scratches or irregularities are present on the surface of the intermediate transfer belt 8, calibration may be stopped due to detection of an abnormality. On the other hand, in a case where the cleaning performance of the cleaning brush 23 has deteriorated, allowing residual toner to remain, a malfunction is caused in which calibration fails to be executed even though the surface condition of the intermediate transfer belt 8 is normal.

To prevent this, in the present embodiment, in a case where an abnormality is detected during bare surface measurement, the execution procedure of calibration is changed. Specifically, in a case where the fluctuation range of the output waveform of the image density sensor 50 during bare surface measurement is equal to or greater than the threshold value, the intermediate transfer belt 8 is rotated once more and bare surface measurement is performed again (a second bare-surface-measurement process). This helps collect residual toner caused by the deterioration of the cleaning performance of the cleaning brush 23, and contributes to normal execution of bare surface detection.

Further, in a case where the bare surface measurement performed during the additional rotation of the intermediate transfer belt 8 has resulted in detection of an abnormality as in the previous rotation, it can be determined that scratches, irregularities, or the like have occurred on the intermediate transfer belt 8. In this manner, it is possible to accurately predict the optimal timing for replacing the intermediate transfer belt 8.

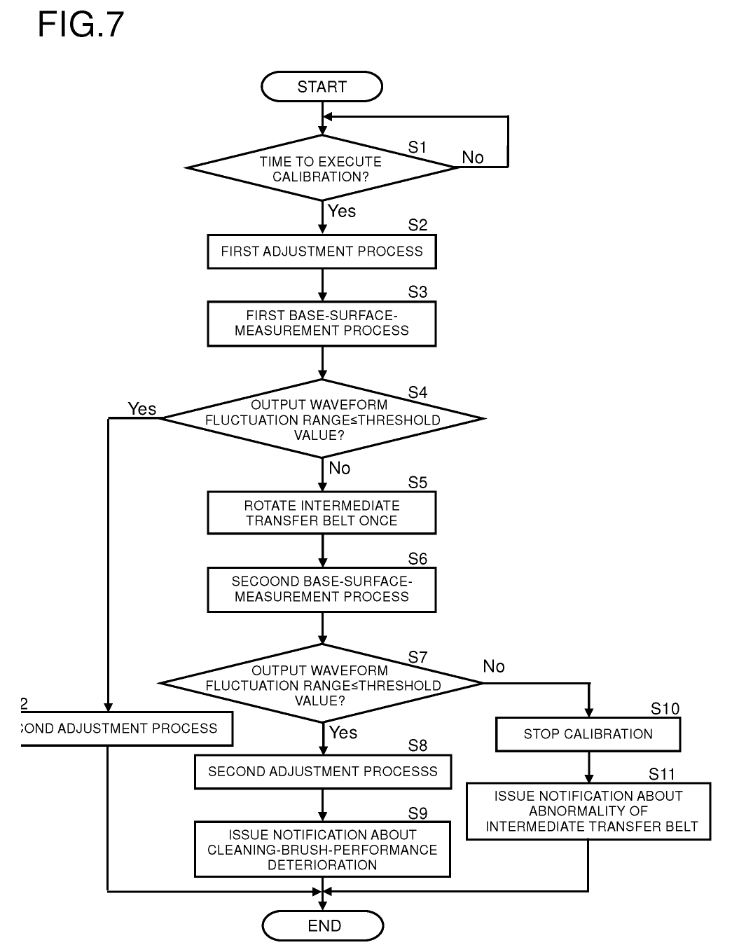

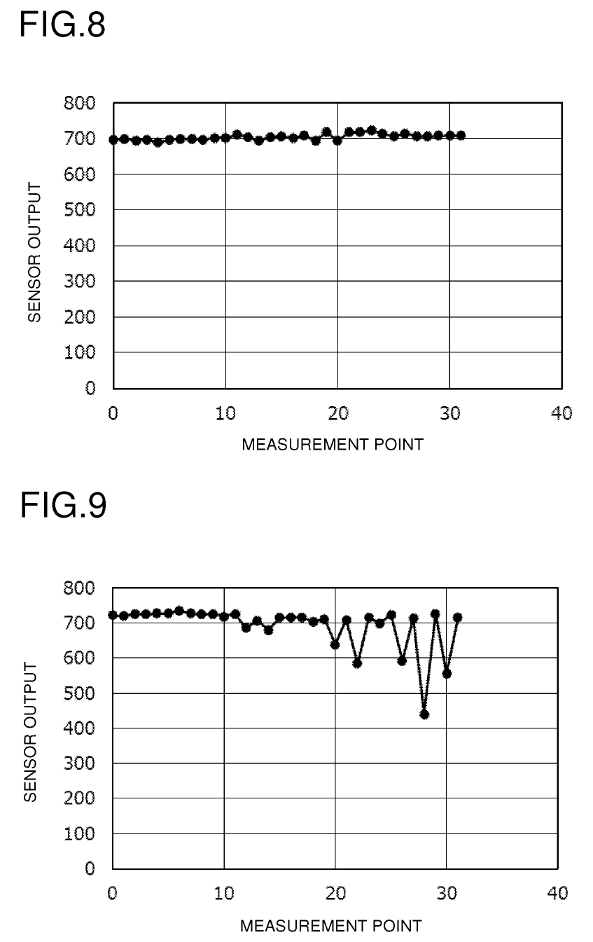

FIG. 7 is a flowchart showing an example of calibration control executed in the image forming apparatus 100. With reference to FIGS. 1 to 6 and later-described FIGS. 8 to 10 as necessary, and following the steps described in FIG. 7, a description will be given of an execution procedure of calibration. Note that FIG. 7 describes calibration in which development voltage correction and gamma correction are performed sequentially as shown in FIG. 5.

First, the control portion 90 determines whether it is time to execute calibration (step S1). The timing of calibration execution is determined, for example, based on whether the cumulative number of sheets printed since the previous calibration has reached a predetermined number.

In a case where it is time to execute calibration (Yes in step S1), first, the first adjustment process is executed (step S2). Specifically, the reference images C1 to K1 (see FIG. 5) are formed on the intermediate transfer belt 8, and the image density sensor 50 performs density detection. Then, development voltage correction is performed based on results of the density detection, and the reference images C1′ to K1′ are formed with corrected development voltages. Furthermore, the image density sensor 50 performs density detection of the reference images C1′ to K1′, and it is determined whether the image densities each have reached a target value.

Subsequently, the intermediate transfer belt 8 is rotated twice for the cleaning brush 23 to collect the reference images C1 to K1 and C1′ to K1′, and then the first bare-surface-measurement process is executed (step S3). The control portion 90 determines whether a fluctuation range of the output waveform is equal to or less than the threshold value (step S4).

FIG. 8 is a graph showing results of bare surface measurement obtained when the performance of the cleaning brush 23 is normal. When the performance of the cleaning brush 23 is normal, by rotating the intermediate transfer belt 8 twice, the reference images C1 to K1 and C1′ to K1′ can be collected completely. Thus, it can be confirmed that the output waveform of the image density sensor 50 is stable.

FIG. 9 is a graph showing results of bare surface measurement obtained when the performance of the cleaning brush 23 has deteriorated. When the performance of the cleaning brush 23 has deteriorated, even by rotating the intermediate transfer belt 8 twice, the reference images C1 to K1 and C1′ to K1′cannot be collected completely. As a result, peaks appear in the output waveform of the image density sensor 50 due to the influence of residual toner.

In a case where, as shown in FIG. 9, peaks appear due to the influence of residual toner, and the fluctuation range of the output waveform exceeds the threshold value (No in step S4), the control portion 90 drives the intermediate transfer belt 8 to rotate once more (step S5). Then, the second bare-surface-measurement process is executed (step S6), and it is determined whether the fluctuation range of the output waveform is equal to or less than the threshold value (step S7).

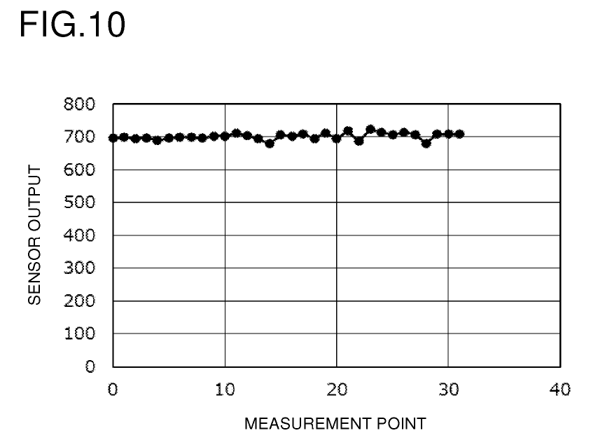

FIG. 10 is a graph showing results of bare surface measurement obtained when the intermediate transfer belt 8 has been rotated once more from the state shown in FIG. 9. It can be confirmed that after rotating the intermediate transfer belt 8 once more, the output waveform of the intermediate transfer belt 8 is stable as in FIG. 8.

In a case where the fluctuation range of the output waveform is equal to or less than the threshold value as shown in FIG. 10 (Yes in step S7), it is determined that the surface condition of the intermediate transfer belt 8 is normal, and the second adjustment process is executed (step S8). Specifically, on the intermediate transfer belt 8, the reference images C2 to K2 (see FIG. 5) are formed, and the image density sensor 50 performs density detection. Then, based on results of the density detection, a parameter value used for gradation correction is determined, and the reference images C2′ to K2′ after the correction of the gradation input value are formed. Furthermore, the image density sensor 50 performs density detection of the reference images C2′ to K2′, and it is determined whether the image densities each have reached a target value. Further, the control portion 90 issues a notification about deterioration of the cleaning performance of the cleaning brush 23 (step S9). Specifically, on the liquid crystal display portion 71 (see FIG. 4), a message is displayed prompting to replace the cleaning brush 23.

In a case where the fluctuation range of the output waveform exceeds the threshold value in step S7 (No in step S7), that is, in a case where the surface condition of the intermediate transfer belt 8 does not return to normal even after the additional rotation of the intermediate transfer belt 8, the control portion 90 determines that scratches or irregularities have been generated on the surface of the intermediate transfer belt 8, and stops the calibration (step S10). Further, the control portion 90 issues a notification regarding the abnormality of the intermediate transfer belt 8 (step S11). Specifically, on the liquid crystal display portion 71 (see FIG. 4), a message is displayed prompting to replace the intermediate transfer belt 8.

On the other hand, in a case where, in step S4, the fluctuation range of the output waveform is equal to or less than the threshold value (Yes in step S4), the second adjustment process is executed without rotating the intermediate transfer belt 8 once more (step S12).

According to the control example shown in FIG. 7, based on the results of bare surface measurement obtained during calibration, deterioration of the performance of the cleaning brush 23 or an abnormality of the intermediate transfer belt 8 can be detected. In a case where the performance of the cleaning brush 23 has deteriorated, the intermediate transfer belt 8 is rotated once more to collect residual toner, thereby making it possible to avoid a malfunction in which calibration fails to be executed. On the other hand, in a case where an abnormality, such as scratches, irregularities, and the like, has occurred on the intermediate transfer belt 8, it is possible to quickly notify a user of the abnormality.

Additionally, it should be understood that the present disclosure may be practiced in any other manner than specifically described above as an embodiment, and various modifications are possible within the scope of the present disclosure. For example, although the image forming apparatus 100 dealt with in the description of the above embodiment is a tandem-type color printer as shown in FIG. 1, the present disclosure is applicable to various types of intermediate transfer type image forming apparatuses provided with a cleaning brush, examples of which are not limited to color printers, but also include color copiers, color multifunction peripherals, etc.

The present disclosure is usable in a cleaning device that uses a cleaning brush to remove residual toner from the surface of an intermediate transfer belt. By using the present disclosure, it is possible to provide an image forming apparatus capable of accurately executing the second stage of two-stage calibration performed using reference images formed on the same part of an intermediate transfer belt.

What is claimed is:

1. An image forming apparatus, comprising:
an image carrying member that includes a photosensitive layer formed on a surface thereof;
a charging device that charges the surface of the image carrying member;
an exposure device that exposes, to light, the surface of the image carrying member having been charged by the charging device, thereby forming an electrostatic latent image with attenuated charge;
a developing device that includes a developer carrying member carrying a developer including toner, and that develops the electrostatic latent image having been formed on the image carrying member into a toner image;
an intermediate transfer belt to which the toner image having been formed on the image carrying member is primarily transferred;
a cleaning brush that removes toner remaining on the intermediate transfer belt;
an image density sensor that detects density of the toner image having been primarily transferred onto the intermediate transfer belt; and
a control portion that executes calibration to correct image density based on density of a reference image having been detected by the image density sensor,
wherein
the calibration includes:
a first adjustment process of detecting density of a first reference image formed on the intermediate transfer belt and adjusting an image forming condition based on a detection result;
a first bare-surface-measurement process of detecting a first-reference-image formation area using the image density sensor when the intermediate transfer belt has rotated once or more after execution of the first adjustment process; and
a second adjustment process of detecting, when the intermediate transfer belt has rotated once after execution of the first bare-surface-measurement process, density of a second reference image formed on the first-reference-image formation area, and changing, based on a detection result, an image forming condition that is different from the image forming condition adjusted in the first adjustment process, and
in a case where a fluctuation range of an output waveform of the image density sensor in the first bare-surface-measurement process is equal to or less than a threshold value, the control portion determines that a surface condition of the intermediate transfer belt is normal, and executes the second adjustment process.

2. The image forming apparatus according to claim 1,
wherein
in a case where the fluctuation range of the output waveform of the image density sensor in the first bare-surface-measurement process exceeds the threshold value, the control portion executes a second bare-surface-measurement process of detecting the first-reference-image formation area using the image density sensor after causing the intermediate transfer belt to rotate once more, and
in a case where a fluctuation range of an output waveform of the image density sensor in the second bare-surface-measurement process is equal to or less than the threshold value, the control portion executes the second adjustment process.

3. The image forming apparatus according to claim 2, further comprising a notification portion capable of issuing notifications regarding conditions of various portions of the image forming apparatus including the cleaning brush,
wherein
in a case where the fluctuation range of the output waveform of the image density sensor in the second bare-surface-measurement process is equal to or less than the threshold value, the control portion, using the notification portion, issues a notification regarding deteriorated performance of the cleaning brush.

4. The image forming apparatus according to claim 2,
wherein
in a case where the fluctuation range of the output waveform of the image density sensor in the second bare-surface-measurement process exceeds the threshold value, the control portion does not execute the second adjustment process and stops the calibration.

5. The image forming apparatus according to claim 4, further comprising a notification portion capable of issuing notifications regarding conditions of various portions of the image forming apparatus including the intermediate transfer belt,
wherein
in a case where the fluctuation range of the output waveform of the image density sensor in the second bare-surface-measurement process exceeds the threshold value, the control portion, using the notification portion, issues a notification prompting replacement of the intermediate transfer belt.

6. The image forming apparatus according to claim 1,
wherein
the first adjustment process is a process in which density of a solid image formed as the first reference image on the intermediate transfer belt is detected, and a development voltage applied to the developer carrying member is adjusted based on a detection result, and
the control portion executes the first bare-surface-measurement process when the intermediate transfer belt has rotated twice after execution of the first adjustment process.

7. The image forming apparatus according to claim 1,
wherein
the second adjustment process is a process in which density of the second reference image formed on the intermediate transfer belt is detected, and at least one of a light amount of the exposure device and a gradation input value is adjusted based on a detection result.
